(19) United States
(12) Patent Application Publication
(10) Pub. No.: US 2023/0153174 A1
(43) Pub. Date: May 18, 2023

(54) DEVICE SELECTION FOR WORKLOAD EXECUTION

(71) Applicant: Intel Corporation, Santa Clara, CA (US)

(72) Inventors: Akhilesh S. THYAGATURU, Tempe, AZ (US); Vinodh GOPAL, Westborough, MA (US); Saidulu ALDAS, San Ramon, CA (US); Anthony W. MOORE, Phoenix, AZ (US)

(21) Appl. No.: 17/528,581

(22) Filed: Nov. 17, 2021

(51) Int. Cl. G06F 9/50

(52) U.S. Cl. CPC G06F 9/5083; G06F 9/5044; G06F 9/505

(57) ABSTRACT

Examples described herein relate to a network interface device. In some examples, the network interface device includes circuitry to provide access to an accelerator device on a second platform to perform a workload in response to communication with a device driver executed by a first platform. In some examples, the first platform and second platform are connected by a network and wherein the accelerator device satisfies a selection criteria and wherein the selection criteria comprises a device type. In some examples, the accelerator device on the second platform is accessible to an application via the device driver.

### BACKGROUND

Accelerator devices are widely used in various technological areas, such as machine learning and genomics. Accelerator devices, such as field programmable gate arrays (FPGAs), cryptography accelerators, graphics accelerators, and/or compression accelerators, are capable of accelerating the execution of a set of operations in a workload. In systems in which workloads are distributed among multiple compute devices, a centralized server may track utilization of compute devices with accelerator devices and assign workloads to compute devices with accelerator devices.

### BRIEF DESCRIPTION OF THE DRAWINGS

FIG. 1 depicts an example system.

FIG. 2 depicts an example system.

FIG. 3 depicts an example system.

FIGS. 4A and 4B depicts an example of a memory transaction between an accelerator service host and acceleration service requester.

FIG. 5 depicts an example sequence.

FIG. 6A depicts a distributed accelerator scenario for Multi-Access Edge Computing (MEC) applications.

FIG. 6B depicts a distributed accelerator scenario for federated learning applications.

FIG. 7 depicts an example process.

FIG. 8 depicts an example network interface device.

FIG. 9 depicts an example computing system.

### DETAILED DESCRIPTION

Data center include platforms with accelerator devices to address sensitive computing demands. Examples of accelerator devices include field programmable gate arrays (FPGAs), graphics processing units (GPUs), dedicated hardware-accelerators such as cryptography and compression accelerator (e.g., Quick Assist Technology (QAT)), data copying with validation (e.g., Data Stream Accelerator (DSA)), workload manager (e.g., Hardware Queue Manager (HQM)), and so forth. Accelerator devices can be accessible on a platform using device interfaces.

Hardware-accelerators spanning across multiple-platforms can be made accessible by applications executing on different platforms. Some examples include a network interface device that is to generate and process traffic based on accelerator parameters of a workload. The configuration of acceleration functions can involve applications and orchestration requesting acceleration support to devices serving the workload requests. Some examples utilize a network interface device to share accessibility to accelerator devices among multiple platforms across a network independent from a CPU that executes an application managing accelerator accessibility. Some examples can increase utilization of platform accelerator infrastructure resources; reduce interrupts to a CPU and management of accelerator workload by the CPU; facilitate inter-platform coordination of hardware resources for federated learning; utilize existing device interface protocol enumeration and protocol transactions between sharing nodes (with potentially no protocol changes); and/or utilize Hypertext Transfer Protocol Secure (HTTPS) sessions to stream the data for accelerator computation and results forwarding.

A network interface device can provide a proxy interface to an accelerator device. When an application submits a job request to the proxy interface, the proxy interface can provide the request in a network IP packet stream and transmit the packet stream to the target accelerator device. The target accelerator device can receive an IP packet stream with memory accesses as peer-to-peer data transfers from the proxy interface. An accelerator function can be emulated on the source location (e.g., where the data resides). Data can be streamed, by an abstracted accelerator function, to a target system. The emulated function at the source location can indicate that the accelerator device is within the same system. However, the emulated function receives descriptors and sets up control information on the target system. Hence, data can be streamed by the abstracted accelerator function, and not by the applications, to the target system.

A platform could expose a remote accelerator as a local accelerator device to an operating system (OS) and applications. A remote accelerator can be accessible through a network using one or more packets. A driver could expose a remote accelerator to an application as a local accelerator. The application could submit a descriptor to an accelerator such as for a local accelerator. The descriptor can specify a data length, memory block identifier, DMA copy operations, and streamer requirements.

In some examples, an accelerator device can be accessible as a SR-IOV or SIOV device. A SR-IOV extension enables multiple virtualized execution environments (e.g., system images) to share PCIe hardware resources under a single-node system (e.g., single root complex). SR-IOV is compatible at least with specifications available from Peripheral Component Interconnect Special Interest Group (PCI SIG) including specifications such as Single Root I/O Virtualization and Sharing specification Revision 1.1 (2010) and variations thereof, earlier versions or updates thereto. A SR-IOV device provides a bus device function (BDF) identifier for a virtual function within a PCIe hierarchy; a unique memory address space for a virtual function (VF) within a PCIe hierarchy; a unique error logging and escalation scheme; a unique MSI/MSI-X capability for each VF within a PCIe hierarchy; and power-management capabilities for each VF within a PCIe hierarchy. In addition, SR-IOV provides the capability to discover and configure virtualization capabilities which include a number of VFs that the PCIe device will associate with a device and the type of base address register (BAR) mechanism supported by the VFs.

A technical specification for S-IOV is Intel® Scalable I/O Virtualization Technical Specification (June 2018). SR-IOV is a PCIe-based virtualization technique that provides for scalable sharing across virtualized execution environments of I/O devices, such as network controllers, storage controllers, graphics processing units, and other hardware accelerators across a large number of virtualized execution environments. Unlike the coarse-grained device partitioning approach of SR-IOV to create multiple VFs on a PF, SR-IOV enables software to flexibly compose virtual devices utilizing the hardware-assists for device sharing at finer granularity. Performance critical operations on the composed virtual device are mapped directly to the underlying device hardware, while non-critical operations are emulated through device-specific composition software in the host.

The remote accelerator can be proxied by the drivers and accelerator proxies via local and remote network interface devices. Network interface devices can support HTTPS streamer implementations of HTTPS protocols.

Applications executing on a platform can communicate with the accelerator of a remote node based on accelerator proxy circuitry in the network interface device. Examples can provide flexibility to accommodate heterogenous accelerators encompassing dedicated accelerators or general-purpose accelerators which process streaming data, rather than large data at-once. Such that the data can be securely communicated, buffered and played-out to an accelerator device.

Applications need not manage remote accelerator contexts and executions and data movements can be managed by a network interface device. Thus, applications and OS can be utilized without modification to access remote accelerator. Examples permit dynamically sharing accelerator resources (e.g., lease temporarily) on a platform with other platforms over an Ethernet network without the dependency on specialized protocols such as InfiniBand and remote direct memory access (RDMA).

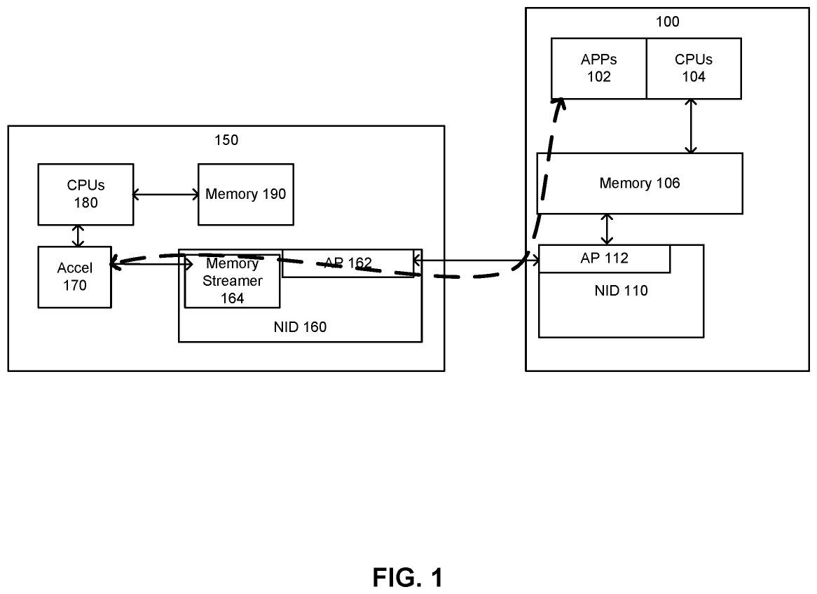

FIG. 1 depicts an example system. In some examples, applications 102 executing on platform 100 can access remote accelerator (Accel) 170 on platform 150. In some examples, as described herein, to access accelerator 170, applications 102 can utilize accelerator proxy (AP) 112 of network interface device (NID) 110 to communicate with AP 162 of NID 160 associated with platform 150. AP 112 can provide applications 102 access to accelerator 170. Memory stream 164 can receive data using a protocol such as HTTPS from NID 110 or transmit data using the same or different protocol to NID 110.

Memory streamer 164 can perform data streaming to fetch data on-demand, and then playback or send the data to the physical accelerator device. Memory stream 164 can utilize an HTTPS session to perform secure streaming, where the data is fetched using a TCP protocol, and then fed to accelerator device 170. In a return direction, memory streamer 164 could write back data to memory locations such that it appears as if the local accelerator device had written to the memory location in memory 106.

NID 160 can be communicatively coupled to accelerator 170 using a device interface such as Peripheral Component Interconnect express (PCIe) or Compute Express Link (CXL), or a memory interface such as an interface compatible with Double Data Rate (DDR) from Joint Electronic Device Engineering Council (JEDEC). Some examples need not utilize remote direct memory access (RDMA) based data sharing between platform 150 and requester platform 100.

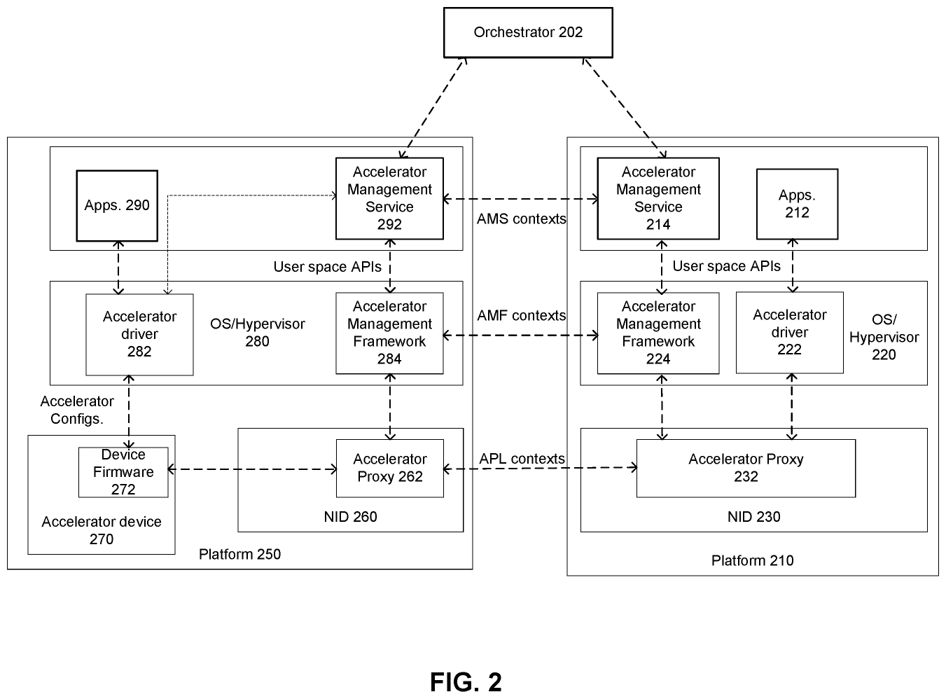

FIG. 2 depicts an example system. Orchestrator 202 can perform scheduling of use of accelerator resources by accelerator device 270 to platforms 210 and 250. For example, orchestrator 202 can permit applications (Apps.) 212 executing on platform 210 to access accelerator device 270 of platform 250. In some examples, orchestrator 202 can scale out performance of a work request on devices and select devices to execute a work request in a selection order or selection criteria such as: application specific integrated circuit (ASIC), field programmable gate array (FPGA), graphics processing unit (GPU), and a CPU. However, other orders of selection of devices can be utilized. Accordingly, if, according to selection order, accelerator device 270 is a selected device to perform a workload request, then the accelerator device 270 can be selected (and potentially configured) to perform the workload. In this example, accelerator device 270 is a selected device to perform the workload request. However, if, according to selection order, accelerator device 270 is not a selected device to perform a workload request, because another accelerator device on another platform (not shown) is selected to perform the workload, then the accelerator device 270 is not selected to perform the workload.

Orchestrator 202 can communicate with platforms 210 and 250 to provide requests, resource use grants, resource availability (e.g., limited time availability of an accelerator to a remote platform), resource monitoring, and so forth. In some examples, orchestrator 202 can communicate with platforms 210 and 250 using REST APIs.

Accelerator management service (AMS) 214, executing on platform 210, and AMS 292, executing on platform 250, can monitor telemetry of resources (e.g., accelerator device 270, and other devices capable of performing a workload (not shown)) and indicate resource availability of such devices to orchestrator 202. AMS 214 can communicate AMS contexts to AMS 292, and vice versa. AMS contexts can include accelerator states, executable binaries, workload parameters, and so forth. Decentralized scheduling can identify accelerator availability based on distributed methods. For instance, if a node does not have enough resource but determines a least cost path to another available resource, such node can direct the request to the available AMS.

Applications 212, executing in user space, can utilize application program interfaces (APIs) to access accelerator device 270 via driver 222. In some examples, accelerator device 270 can be accessible as a device connected using a device interface but accelerator proxy 232 of NID 230 can communicate with accelerator device 270 via accelerator proxy 262 of NID 250 to cause a workload to be performed by accelerator device 270. Applications 212 can launch a thread to determine which resources are available to execute a workload. In this example, orchestrator 202 select accelerator device 270 to execute a workload for applications 212.

Applications (Apps.) 290, executing on platform 250, can cause accelerator device 270 to perform a workload using accelerator driver 282. In some cases, where platform 210 includes device resources to perform a workload for applications 290, applications 290 can utilize accelerator proxy 262 to communicate with accelerator proxy 232 of platform 210 to access such device resource.

Note that reference to an application can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

For example, accelerator management framework (AMF) 224 can be utilized by operating system (OS) or hypervisor 220 in order to manage and oversee communications among NID 230 and NID 260. AMF 224 could keep track of resource utilization, available, sharing capacity, acceleration type, etc. AMF 224 could instantiate control information on am accelerator device such that the physical hardware is configured to the requirements of the requestor to perform a workload. Configuration examples could include queue depth, service type, duration of the accelerator sharing enabled, and so forth.

Accelerator proxy 232 can be accessible as a device (e.g., PCIe or CXL device) to OS 220 and applications 212. Likewise, accelerator proxy 262 can be accessible as a device (e.g., PCIe or CXL device) to OS 280. Accelerator proxy 262 can be configured to communicate with accelerator proxy 232 at least in connection with performance of workloads for applications 212 by accelerator device 270. Accelerator Management Service (AMS) 214 can configure accelerator proxy 232 as a proxy device to interact with accelerator proxy 262 to utilize accelerator device 270. Proxy 232 can manage execution of a workload by accelerator device 270 on behalf of applications 212. Accelerator proxy 232 and accelerator proxy 262 can be implemented as firmware executed by respective network interface devices 230 and 260. Accelerator proxy 262 can submit workload or job requests to accelerator 270.

Accelerator device 270 can perform operations including one or more of: data encryption, data decryption, data compression, data decompression, and other operations. Accelerator device 270 can be implemented as one or more of: an application specific integrated circuit (ASIC), field programmable gate array (FPGA), graphics processing unit (GPU). Device firmware 272 can be executed by accelerator device 270 to respond to commands from accelerator proxy 262, such as performance of a workload for applications 212. Device firmware 272 can be executed by accelerator device 270 to respond to commands from applications 290 to perform a workload for applications 290. For example, performance of a workload can include computation on data identified by applications 212 or 290.

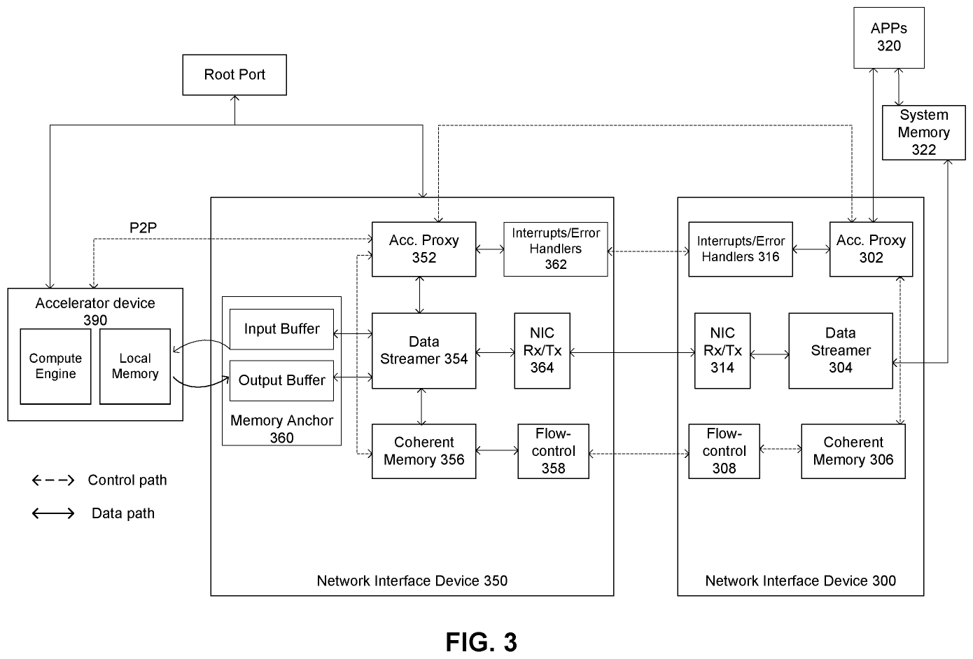

FIG. 3 depicts an example of accelerator sharing. Some examples decouple accelerator compute data path from CPU and system memory. In some examples, data is streamed in-and-out of a platform through a NID, via memory anchoring enabled by buffers for copying of data from accelerator device to NID.

In some examples, applications 320 can request use of an accelerator 390 to perform a workload by communication between accelerator proxy 302 and accelerator proxy 352. Accelerator proxy 302 of NID 300 can request accelerator proxy 352 of NID 350 to perform the workload. Accelerator proxy 302 can be accessible as a PCIe (or other interface) device to applications 320 via a driver. Data Steamers 304 and 354 can establish an end-to-end streaming protocol based on Internet Protocol (IP) connectivity such that data associated with a workload is transmitted and received between NID 300 and NID 350 using stateful (e.g., Transmission Control Protocol (TCP)) and stateless connections (e.g., User Datagram Protocol (UDP)).

Coherent Memory 306 and 356 can manage data flow between memory of accelerator device 390 and system memory 322. Coherent Memory 306 and 356 can perform data tracking, streaming estimation, and control coordination for data transfers.

Flow control 308 and 358 can establish data play-out based traffic estimation and control to attempt to avoid buffer overflow based on compute capacity of accelerator device 390 and network bandwidth.

NID 350 can copy data into memory of accelerator device 390 then transmit the result to system memory 322 of the requester node. Communication between NID 350 and accelerator 390 can occur through a PCIe connection between accelerator proxy 352 executing in NID 350. Peer-to-peer communication can occur to enable direct interaction between two PCIe or CXL devices with configuration occurring on the PCIe or CXL device peer-nodes.

Memory anchor 360 can provide an input buffer and output buffer to regulate requests to input/output (I/O) of accelerator device 390. Interrupt/Error Handlers 362 and 316 can manage interrupts and errors reported by accelerator device 390 and forward the interrupts to accelerator proxy circuitry or logic (APL), AMS, or to a requestor host (for its APL or AMS).

A root port can be a controller of the PCIe or CXL devices and perform enumeration, assignment of Bus, Device, Function (BDF) identification, and perform exception catching, error notification, and other memory management functions.

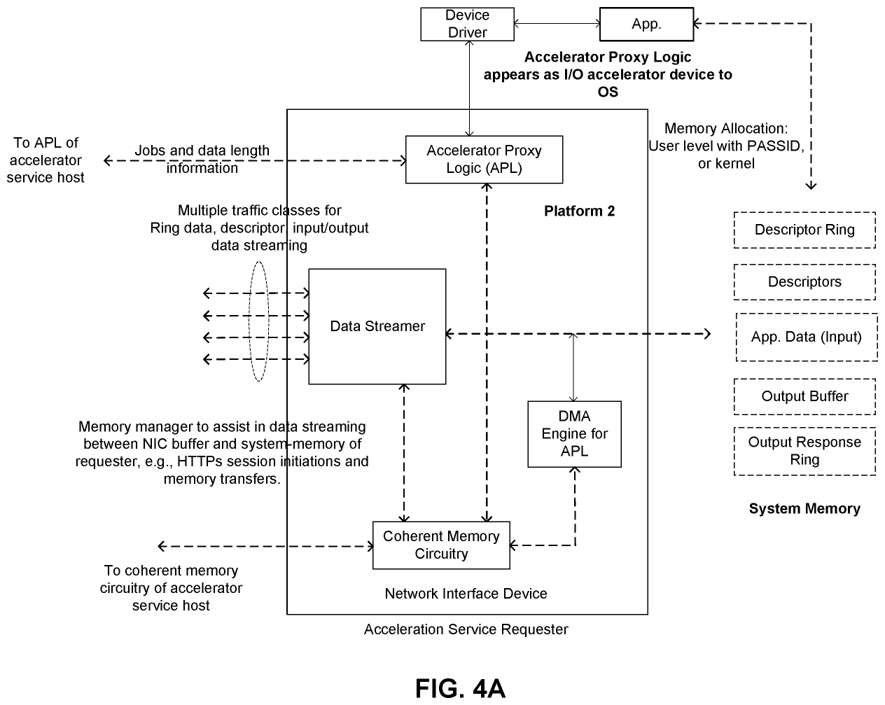

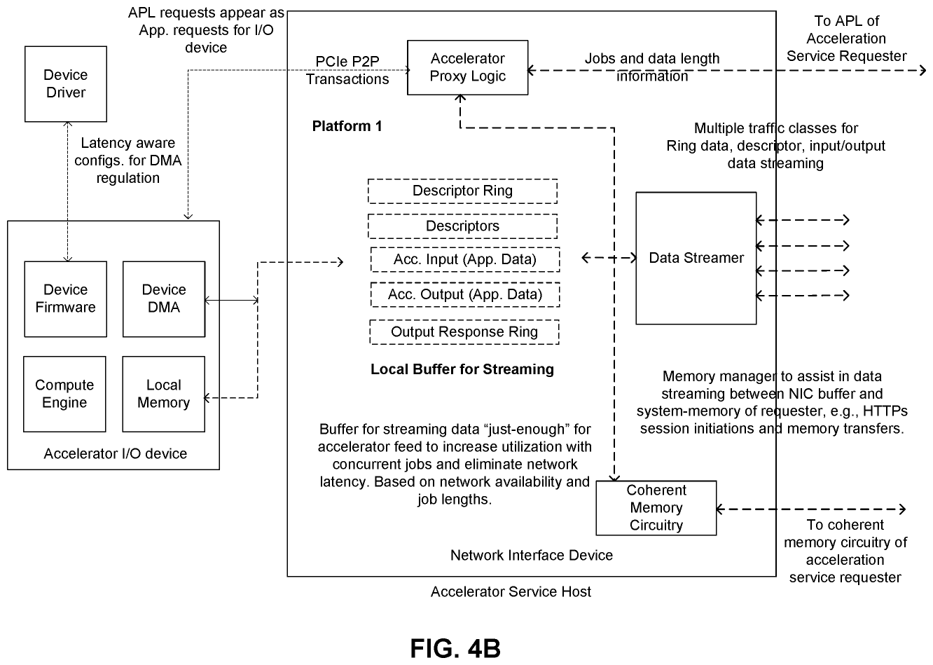

FIGS. 4A and 4B depicts an example of a memory transaction between an accelerator service host and acceleration service requester. Application data in the memory can be copied from a requester host platform to service host platform through a direct memory access (DMA) engine and NID-to-NID communication. The streaming of data can be performed using different classes of traffic. The streaming of data through different traffic classes can be performed via IP connections. Data can be submitted to accelerator device for processing.

Buffers can be used to regulate in the variation in the networking variations. High priority traffic classes can be allocated for ring and descriptor data. Data can be streamed in chunks, e.g., 4 KB or other sizes of data per DMA operation. Buffer play-out of a job into accelerator device can utilize parallel job queues to increase utilization of accelerators. For sufficiently high bandwidth and low latency, accelerator usage of 100% can be achieved with asynchronous job submissions.

If a buffer read fails, coherent memory can manage the memory re-read, based on page fault resolution mechanism. If the local buffer runs out of data, and bandwidth is available, the data can be moved to local memory of the accelerator device platform.

Memory anchor can perform queue management (e.g., first-in-first-out (FIFO)), manage cache space, or manage a virtual memory image of requester DRAM memory. Address mapping can be retained such that memory re-read requests can be placed by Coherent Memory Logic (CML). An invalid read addresses can be identified at the DMA engine of the requester.

Completion interrupts can be forward through Interrupt and error handlers, and forwarded to APL for delegations to applications and accelerator management framework (AMF) (e.g., driver). Polling based result completion at the requester side could allow the application thread to monitor for completions, while the APL-to-APL communications can occur through traffic flow-based interrupt forwarding.

Coherent memory circuitry can prioritize DMA waits first before pulling content ahead. Buffer Status Reports can be sent from APL of a service host to accelerator firmware such that DMA operations can be regulated.

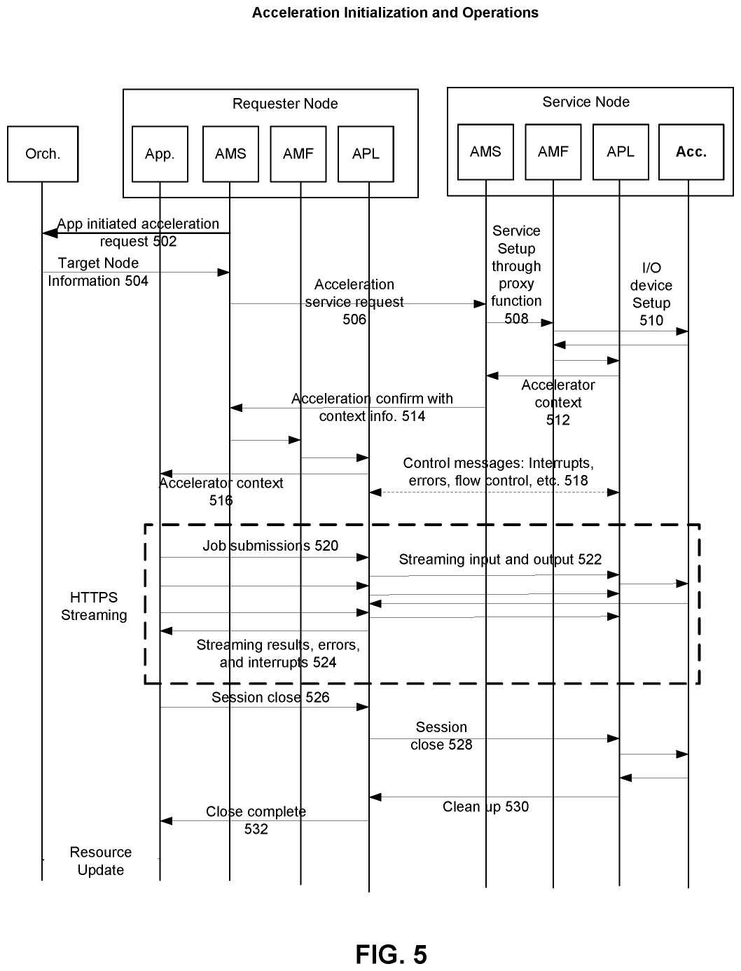

FIG. 5 depicts an example sequence. At 502, an application can initiate a workload acceleration request to an orchestrator. In some examples, x86 instruction commands ENQCMD and MOVDIR64B allows application to dispatch instruction to AMS, AMF, and/or APL of a requester host node. At 504, the orchestrator can provide target node information of a device to use to perform the workload. Information of the device can include target node information such as one or more of: IP address of target node, accelerator hardware identifier, QoS, time to complete execution, and so forth.

At 506, an acceleration service request can be provided by AMS to AMS of a service node that includes the device identified by the orchestrator. At 508, the AMS of the service node can setup a proxy through the AMF of the service node. At 510, the AMF of the service node can set up the accelerator device (Acc.) to perform a workload. At 512, the accelerator context (e.g., executable binary, workload state, and so forth) can be shared with the AMS of the service node. An accelerator context can be shared, configured, saved, instantiated such that the acceleration service continuity can be enabled at a different physical device. At 514, acceleration confirmation can be provided to AMS of the workload requester. At 516, accelerator context can be provided to the application. At 518, control messages such as interrupts, errors, flow control, and so forth can be communicated between APLs of requester and service nodes.

At 520, the application can provide a job submission to the accelerator device. At 522, data can be streamed to the accelerator from the requester node and a response provided from the service node to the requester node. At 524, the results of the accelerator performance of the workload as well as errors or interrupts can be provided to the application. At 526, the application can request a session close and at 528, the APL of the requester node can request a session closure to the APL of the service node. At 530, the APL of the service node can perform clean up in connection with the session closure. At 532, the APL of the requester node can indicate to the application that the session close is complete.

Various use cases are discussed next. For example, GPU sharing across multiple platforms through a NID can occur using examples described herein. In an example scenario, web-based media streaming transcoders translate the data-format and resolution based on client's bandwidth and display characteristics (screen-size) for every media frame.

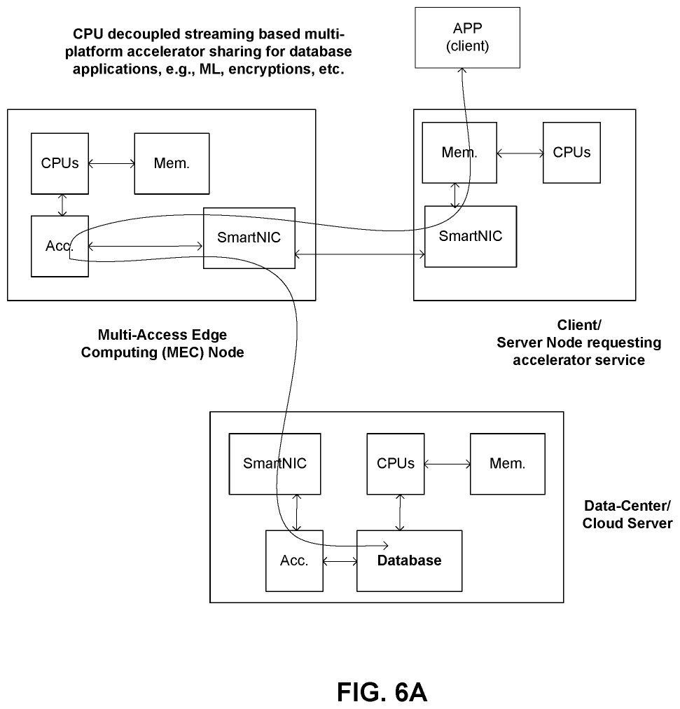

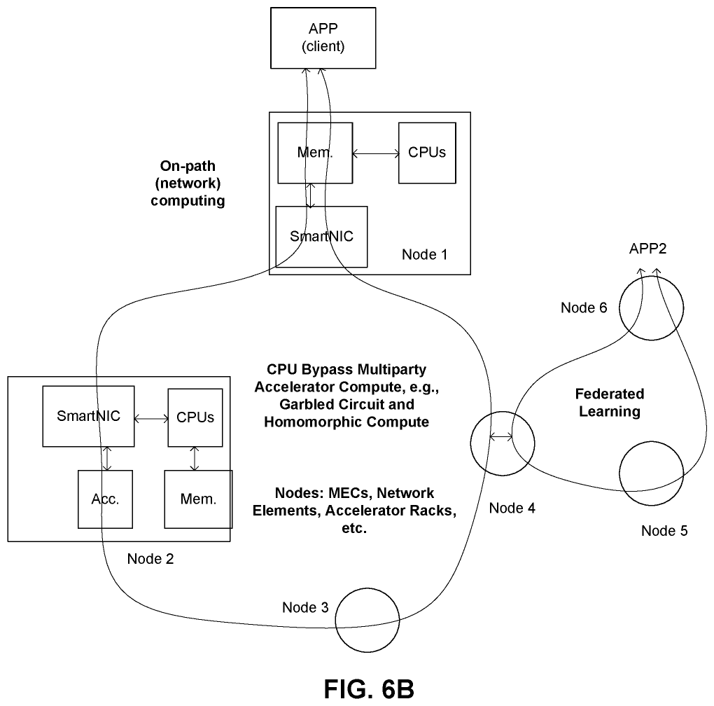

FIG. 6A depicts a distributed accelerator scenario for Multi-Access Edge Computing (MEC) applications. MECs are utilized in wireless and cellular infrastructure to support aspects of Internet of Things (IoT), such as vehicular, healthcare and industrial networks. Data traverses from node-to-node, where data computation can be performed along the network path. For instance, a raw video footage from the traffic light camera, can be compressed and encrypted, and processed for anomalies along network path in a distributed way. In datacenters, MEC, and networking-nodes (e.g., base stations, gateways, etc.) are equipped with accelerators. Based on the workload requirements, the accelerator usages are highly dynamic in nature such that the need for acceleration on a given platform is highly time varying. As a result, it is more likely that neighboring platform hardware-resources are free and could be shared with another platform which has high demand for workload acceleration through the network.

FIG. 6B depicts a distributed accelerator scenario for federated learning applications. Multi-Party Compute (MPC) and Federated Learning are technologies which involve distributed computing on multiple entities, where the data resides on the node, but the inferences (results of compute) are shared between the nodes once the compute operations are completed. Data security can be supported as data does not leave a node, but compute results are shared. MPC and Federated learning can be applied to Privacy Preserving Machine Learning (PPML), Homomorphic Compute and Homomorphic Encryption applications.

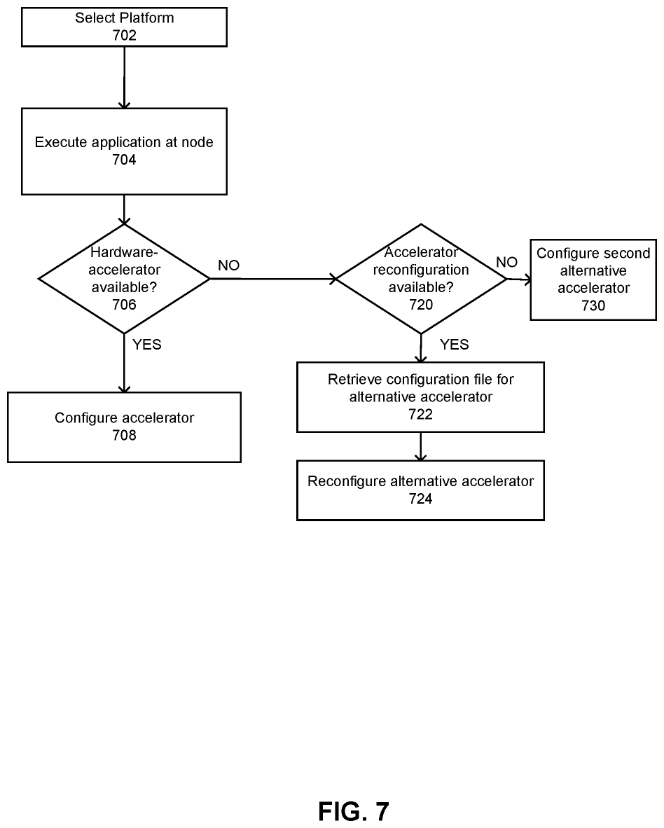

FIG. 7 depicts an example process. The process can be performed by an orchestrator in response to a request to instantiate or execute an application or migrate an application to another node or platform. A migration trigger at the source can be based on not meeting certain performance characteristics. At 702, selection of a platform on which to execute the application can occur. At 704, the application can be executed on the selected platform. The orchestrator can send a request to the selected platform to instantiate a workload. For instantiation, a VM image can be applied. For migration, a pre-copy of the VM state and context can occur, VM state and context can be applied, and post-copy can be applied at the target node.

At 706, a determination can be made if a hardware accelerator is available for use by the application. If an accelerator is available at the platform that is connected through a device interface to a processor that executes the application, the process can continue to 708. For example, if an ASIC accelerator is a first option and is available, the process can continue to 708. If an ASIC accelerator is not available at the platform that is connected through a device interface to a processor that executes the application, the process can continue to 720. Note that accelerators other than ASIC can be set as a first option (preferred) accelerator type. A first option (preferred) accelerator or device type can be an FPGA, GPU, or other device.

At 708, an accelerator configuration can be applied for the hardware accelerator. Accelerator configuration can be based on an accelerator formerly utilized by the application prior to migration. Accelerator configuration can include an executable binary, context of processing completed prior to migration, and other context or data. The application can utilize the accelerator to perform a workload.

At 720, a determination can be made if an accelerator reconfiguration capability is available for use. If an alternate accelerator device or offload device is available, the process can continue to 722. If an alternate accelerator device or offload device is not available, the process can continue to 730. For example, a first option can be an ASIC and an alternate accelerator device or offload device can be a second or subsequent preference such as an FPGA or GPU. However, any order of preference can be applied.

At 722, a configuration file for the alternate accelerator can be retrieved. For example, a database for the accelerator (e.g., FPGA or GPU) can be retrieved. At 724, the alternate accelerator can be configured using the configuration file. The application can utilize the accelerator to perform a workload.

At 730, a second alternative accelerator can be configured to perform offloaded tasks for the application. For example, a first choice accelerator can be an ASIC, a second choice accelerator can be an FPGA, a third choice accelerator can be a GPU, and a fourth choice accelerator can be a CPU that executes the application. For example, if the second alternative accelerator is a GPU, the GPU can be configured to perform offloaded tasks for the application.

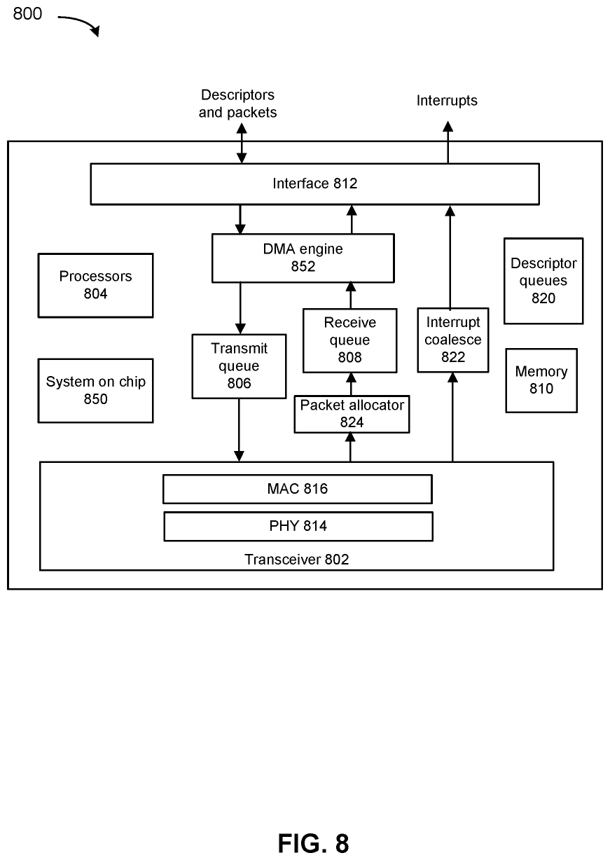

FIG. 8 depicts an example network interface device. The network interface device can include processors to perform a proxy for accelerator device access and configuration, as described herein. Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values.

Processors 804 can be any a combination of a: processor, core, graphics processing unit (GPU), field programmable gate array (FPGA), application specific integrated circuit (ASIC), or other programmable hardware device that allow programming of network interface 800. For example, a “smart network interface” can provide packet processing capabilities in the network interface using processors 804. Configuration of operation of processors 804, including its data plane, can be programmed using Programming Protocol-independent Packet Processors (P4), C, Python, Broadcom Network Programming Language (NPL), or x86 compatible executable binaries or other executable binaries. Processors 804 can execute instructions to perform a proxy for accelerator device access and configuration, as described herein.

System on chip 850 can include microprocessors that execute instructions to perform a proxy for accelerator device access and configuration, as described herein.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

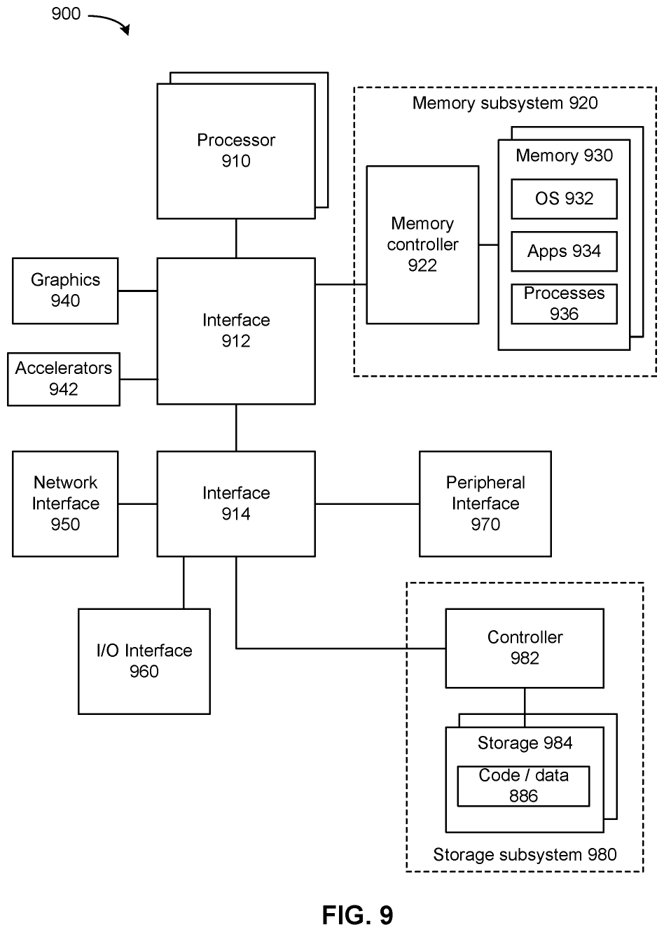

FIG. 9 depicts an example computing system. Components of system 900 (e.g., processor 910, network interface 950, and so forth) to provide a proxy to access an accelerator device access, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure network interface 950 to perform accelerator proxy operations, as described herein. In some examples, a driver can enable or disable offload to network interface 950 to perform accelerator proxy operations, as described herein. A driver can advertise capability of network interface 950 to perform accelerator proxy operations, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache.

A non-volatile memory (NVM) device is a memory whose state is determinate even if power is interrupted to the device. In one embodiment, the NVM device can comprise a block addressable memory device, such as NAND technologies. A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, edge servers, edge switches, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.”

Illustrative examples of the devices, systems, and methods disclosed herein are provided below. An embodiment of the devices, systems, and methods may include one or more, and combination of, the examples described below.

Example 1 includes a system comprising: a network interface device comprising circuitry to provide access to an accelerator device on a second platform to perform a workload in response to communication with a device driver executed by a first platform, wherein the first platform and second platform are connected by a network and wherein the accelerator device satisfies a selection criteria and wherein the selection criteria comprises a device type.

Example 2 includes one or more examples, wherein the accelerator device on the second platform is accessible to an application via the device driver.

Example 3 includes one or more examples, wherein the accelerator device is presented to an operating system (OS) and application executed by the first platform as accessible through a device interface.

Example 4 includes one or more examples, wherein the network interface device is to provide data streaming of data to the second platform to the accelerator device.

Example 5 includes one or more examples, wherein the selection criteria comprises: an application specific integrated circuit (ASIC) accelerator as a first choice, a field programmable gate array (FPGA) accelerator as a second choice, and a graphics processing unit (GPU) accelerator as a third choice.

Example 6 includes one or more examples, wherein: based on the selection criteria not being satisfied, the accelerator device comprises a central processing unit (CPU) to perform the workload.

Example 7 includes one or more examples, wherein the network interface device comprise one or more of: an infrastructure processing unit (IPU), data processing unit (DPU), smartNIC, forwarding element, router, switch, network interface controller, or network-attached appliance.

Example 8 includes one or more examples, comprising the first platform, wherein the first platform is to execute an application and the device driver and wherein the application is to request that the accelerator device execute a workload.

Example 9 includes one or more examples, comprising a data center that includes the first platform, the network interface device, and the second platform, wherein the second platform is to provide limited time access to the accelerator device to the first platform.

Example 10 includes one or more examples, and includes a non-transitory computer-readable medium comprising instructions, that if executed by one or more processors, cause the one or more processors to: configure a network interface device to provide communications with a device to perform offloaded operations from an application, wherein the device is remote from the application and the device satisfies a selection order of device types.

Example 11 includes one or more examples, wherein to provide communications with a device to perform offloaded operations from an application, the network interface device is to communicate with a proxy device in a second network interface device associated with the device.

Example 12 includes one or more examples, wherein the network interface device is to provide data streaming of data to a second network interface device associated with the device.

Example 13 includes one or more examples, wherein the selection order comprises: an application specific integrated circuit (ASIC) accelerator as a first choice, a field programmable gate array (FPGA) accelerator as a second choice, and a graphics processing unit (GPU) accelerator as a third choice.

Example 14 includes one or more examples, comprising instructions, that if executed by one or more processors, cause the one or more processors to: based on the selection order not being satisfied, select a central processing unit (CPU) to perform the offloaded operations.

Example 15 includes one or more examples, wherein to provide communications with a device to perform offloaded operations from an application, the network interface device is to communicate with a proxy device in a second network interface device associated with the device.

Example 16 includes one or more examples, wherein the network interface device comprise one or more of: an infrastructure processing unit (IPU), data processing unit (DPU), smartNIC, forwarding element, router, switch, network interface controller, or network-attached appliance.

Example 17 includes one or more examples, and includes a method comprising: a network interface device providing communications with a device to perform offloaded operations from an application, wherein the device is remote from the application and the device satisfies a selection order of types of devices.

Example 18 includes one or more examples, wherein providing communications with a device to perform offloaded operations from an application, the network interface device communicates with a proxy device in a second network interface device associated with the device.

Example 19 includes one or more examples, wherein the selection order comprises: an application specific integrated circuit (ASIC) accelerator as a first choice, a field programmable gate array (FPGA) accelerator as a second choice, and a graphics processing unit (GPU) accelerator as a third choice.

Example 20 includes one or more examples, comprising: based on the selection order not being satisfied, selecting a central processing unit (CPU) to perform the offloaded operations.

1. A system comprising:
a network interface device comprising circuitry to provide access to an accelerator device on a second platform to perform a workload in response to communication with a device driver executed by a first platform, wherein the first platform and second platform are connected by a network and wherein the accelerator device satisfies a selection criteria and wherein the selection criteria comprises a device type.

2. The system of claim 1, wherein the accelerator device on the second platform is accessible to an application via the device driver.

3. The system of claim 2, wherein the accelerator device is presented to an operating system (OS) and application executed by the first platform as accessible through a device interface.

4. The system of claim 1, wherein the network interface device is to provide data streaming of data to the second platform to the accelerator device.

5. The system of claim 1, wherein the selection criteria comprises:
an application specific integrated circuit (ASIC) accelerator as a first choice, a field programmable gate array (FPGA) accelerator as a second choice, and a graphics processing unit (GPU) accelerator as a third choice.

6. The system of claim 1, wherein:
based on the selection criteria not being satisfied, the accelerator device comprises a central processing unit (CPU) to perform the workload.

7. The system of claim 1, wherein the network interface device comprise one or more of: an infrastructure processing unit (IPU), data processing unit (DPU), smartNIC, forwarding element, router, switch, network interface controller, or network-attached appliance.

8. The system of claim 1, comprising the first platform, wherein the first platform is to execute an application and the device driver and wherein the application is to request that the accelerator device execute a workload.

9. The system of claim 8, comprising a data center that includes the first platform, the network interface device, and the second platform, wherein the second platform is to provide limited time access to the accelerator device to the first platform.

10. A non-transitory computer-readable medium comprising instructions, that if executed by one or more processors, cause the one or more processors to:
configure a network interface device to provide communications with a device to perform offloaded operations from an application, wherein the device is remote from the application and the device satisfies a selection order of device types.

11. The computer-readable medium of claim 10, wherein to provide communications with a device to perform offloaded operations from an application, the network interface device is to communicate with a proxy device in a second network interface device associated with the device.

12. The computer-readable medium of claim 10, wherein the network interface device is to provide data streaming of data to a second network interface device associated with the device.

13. The computer-readable medium of claim 10, wherein the selection order comprises:
an application specific integrated circuit (ASIC) accelerator as a first choice, a field programmable gate array (FPGA) accelerator as a second choice, and a graphics processing unit (GPU) accelerator as a third choice.

14. The computer-readable medium of claim 10, comprising instructions, that if executed by one or more processors, cause the one or more processors to:
based on the selection order not being satisfied, select a central processing unit (CPU) to perform the offloaded operations.

15. The computer-readable medium of claim 10, wherein to provide communications with a device to perform offloaded operations from an application, the network interface device is to communicate with a proxy device in a second network interface device associated with the device.

16. The computer-readable medium of claim 10, wherein the network interface device comprise one or more of: an infrastructure processing unit (IPU), data processing unit (DPU), smartNIC, forwarding element, router, switch, network interface controller, or network-attached appliance.

17. A method comprising:
a network interface device providing communications with a device to perform offloaded operations from an application, wherein the device is remote from the application and the device satisfies a selection order of types of devices.

18. The method of claim 17, wherein providing communications with a device to perform offloaded operations from an application, the network interface device communicates with a proxy device in a second network interface device associated with the device.

19. The method of claim 17, wherein the selection order comprises:
an application specific integrated circuit (ASIC) accelerator as a first choice, a field programmable gate array (FPGA) accelerator as a second choice, and a graphics processing unit (GPU) accelerator as a third choice.

20. The method of claim 17, comprising:
based on the selection order not being satisfied, selecting a central processing unit (CPU) to perform the offloaded operations.
